(19) United States
(12) Patent Application Publication
(10) Pub. No.: US 2019/0171398 A1
(43) Pub. Date: Jun. 6, 2019

(54) IMAGE FORMING APPARATUS, PROGRAM, AND INFORMATION PROCESSING APPARATUS

(71) Applicant: KONICA MINOLTA, INC., Tokyo (JP)

(72) Inventor: Tetsuya ISHIDA, Tokyo (JP)

(73) Assignee: KONICA MINOLTA, INC., Tokyo (JP)

(21) Appl. No.: 16/202,168

(22) Filed: Nov. 28, 2018

(30) Foreign Application Priority Data
Dec. 1, 2017 (JP) 2017-232075

(51) Int. Cl. G06F 3/12

(52) U.S. Cl. CPC G06F 3/1221; G06F 3/1236; G06F 3/1292

(57) ABSTRACT

An image forming apparatus includes: a power supply controller; a network part that performs network communication with a terminal on which operation for an own apparatus is performed; a screen data generator that generates screen data; a screen data transmitter that transmits the screen data to the terminal; and a screen data transmission controller that performs determination as to whether to perform preliminary transmission of the screen data, and when it is determined that preliminary transmission is necessary, the screen data transmission controller notifies the terminal that preliminary transmission of the screen data is to be performed, instructs the screen data generator to generate the screen data to be transmitted in preliminary transmission, instructs the screen data transmitter to perform preliminary transmission of the generated screen data, and causes the power supply controller to shift a power supply state to a power saving state.

The entire disclosure of Japanese patent Application No. 2017-232075, filed on Dec. 1, 2017, is incorporated herein by reference in its entirety.

### BACKGROUND

### Technological Field

The present invention relates to an image forming apparatus, a program, and an information processing apparatus.

### Description of the Related Art

Conventionally, a multi-functional image forming apparatus having a printing function, a copying function, a reading (scanning) function, etc. has been widely used. The image forming apparatus of this type is also referred to as a multi-functional peripheral (MFP).

Recently, user's interest in the global environmental problems has increased to make environmental regulations surrounding MFP stricter year after year. The environmental regulations surrounding the MFP are determined on the basis of ENERGY STAR (registered trademark) or the like. ENERGY STAR (registered trademark) is an international system for implementing a power saving program for electrical devices in cooperation with Japan and the United States, countries such as European Union (EU) and other regions.

In order to reduce the waiting time until the printed matter is output, the MFP performs control such as keeping the fixing device for fixing the toner image formed on a sheet at a constant temperature, leading to high power consumption in a normal state. Therefore, in a case where a non-use state continues for a certain period of time, the MFP is usually controlled to shift from a standby state to a power saving state (also referred to as a sleep state) in which power consumption is lower than in the standby state so as to reduce the power consumption.

Meanwhile, with the spread of mobile terminals such as tablets, smartphones or the like, MFPs are on a way to achieve compatibility with not only wired networks but also wireless networks. That is, the MFP is required to be capable of receiving a print request all the time through the network in the power saving state.

Furthermore, when World Wide Web (Web)-based user interface (UI) display, namely, Web UI is adopted, the frequency of access from mobile terminals to the MFP via the web is expected to increase.

In addition, the MFP can include a function (for example, an expense adjustment system) for performing a single task on a cloud basis. Users not only use prints, copies, and scans, but also are going to more frequently use the MFP to perform single tasks such as accounting and salary on a cloud basis. Due to this circumstance, the MFP needs to receive a request from a mobile terminal or the like even in a power saving state where the power supply of the CPU/memory and the network function etc. is turned off while there is no output of the printed matter.

JP 2015-159564 A discloses a technique of prefetching computer readable instructions related to the execution of one or more applications and/or functions on a mobile device in response to detection of arrival of the mobile device at a certain location. This technique can be used to execute computer readable instructions and activate applications and/or functions without user initiated input or selection events.

JP 2014-27422 A discloses a technique related to a communication terminal including a power management unit that controls power supply to a communication device in accordance with a detection result of the start and end of a session on connection, detected by a communication management unit.

JP 2014-123795 A discloses a technique in which a control unit of a sub device transmits address information and device information of an own device on a wireless network and a wired network to a parent device when requesting a substitute response to the parent device, and thereafter shifts the operation state of the own device to a power saving state, and after receiving a return request from the parent device, the control unit shifts the operation state of the own device from the power saving state to a standby state.

Meanwhile, the technique disclosed in JP 2015-159564 A is processing of requesting and obtaining beforehand an application or a function needed by a user from a mobile device side to a server or the like in accordance with a situation of the mobile device. However, with a method by which the mobile device accesses the MFP via the web for each of mobile devices and requests and obtains an application or a function from the MFP each of occasions of access, it would be difficult to maintain the power saving state of the MFP.

The technique disclosed in JP 2014-27422 A controls power supply in accordance with a communication connection status of a mobile terminal However, with a method by which the MFP transfers data in response to each of the requests from the mobile terminal, it is difficult to maintain the power saving state of the MFP.

The technique disclosed in JP 2014-123795 A is processing in which another MFP performs substitute response in place of the MFP in the power saving state. In order to make a substitute response, another MFP needs to hold data for substitute response beforehand However, the screen data for displaying the operation screen on a terminal has a large data size. In a case where all patterns of screen data having such a large data size are held beforehand in the parent device, the data storage region of the parent device might be overstrained. Furthermore, in a situation where there is no MFP to be a parent device that can handle a request of substitute response, it would be difficult to implement the technique disclosed in JP 2014-123795 A.

### SUMMARY

The present invention has been made in view of such situations, and aims to maintain an image forming apparatus in a power saving state as much as possible even in a situation where access traffic from a terminal is heavy.

To achieve the abovementioned object, according to an aspect of the present invention, an image forming apparatus reflecting one aspect of the present invention comprises: a power supply controller that controls a power supply state of an own apparatus; a network part that performs network communication with a terminal on which operation for the own apparatus is performed; a screen data generator that generates screen data for configuring an operation screen displayed on the terminal; a screen data transmitter that transmits the screen data to the terminal via the network communication; and a screen data transmission controller that performs determination as to whether to perform preliminary transmission of the screen data for which an acquisition request has been received from the terminal, and in a case where the screen data transmission controller determines that preliminary transmission is necessary, the screen data transmission controller notifies the terminal that preliminary transmission of the screen data is to be performed, instructs the screen data generator to generate the screen data to be transmitted in preliminary transmission, instructs the screen data transmitter to perform preliminary transmission of the screen data generated by the screen data generator, and together with this, notifies the power supply controller that the power supply state can be shifted to a power saving state so as to cause the power supply controller to shift the power supply state to the power saving state.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating an overall configuration example of a communication system according to a first embodiment of the present invention;

FIG. 2 is a block diagram illustrating an internal configuration example of an MFP according to the first embodiment of the present invention;

FIG. 3 is a sequence diagram illustrating an operation example of a conventional communication system;

FIG. 4 is a sequence diagram illustrating an operation example of a communication system according to the first embodiment of the present invention;

FIG. 5 is a sequence diagram illustrating an operation example when the MFP according to the first embodiment of the present invention transmits a home screen to a terminal;

FIG. 6 is a flowchart illustrating a processing example of the MFP according to the first embodiment of the present invention;

FIG. 7 is a table illustrating a configuration example of a preliminary transmission UI data determination table according to the first embodiment of the present invention;

FIG. 8 is a flowchart illustrating a processing example of generation and transmission of preliminary transmission UI data illustrated in step S35 of FIG. 6;

FIGS. 9A and 9B are explanatory diagrams illustrating examples of link information set in the UI data according to the first embodiment of the present invention;

FIG. 10 is a block diagram illustrating an overall configuration example of a communication system according to a second embodiment of the present invention;

FIG. 11 is a block diagram illustrating an internal configuration example of an information processing apparatus according to the second embodiment of the present invention; and

FIG. 12 is a sequence diagram illustrating an operation example of the communication system according to the second embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. Note that in this specification and the drawings, the same reference numerals are given to constituent elements having substantially the same function or configuration, and redundant description will be omitted.

### Overall Configuration Example of Communication System

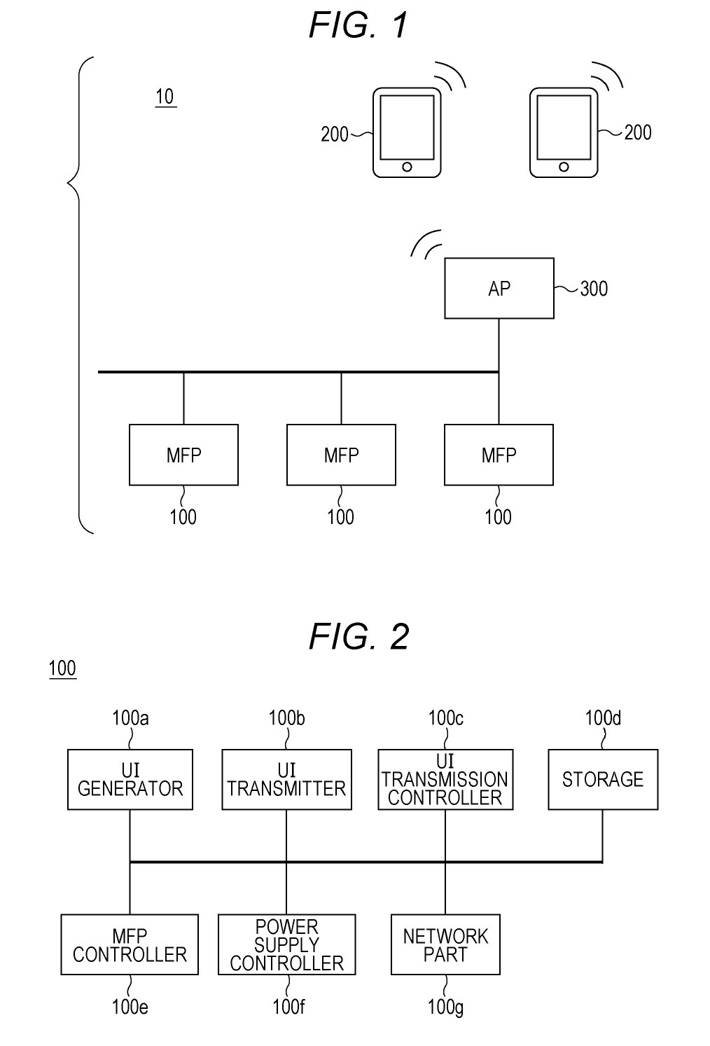

FIG. 1 is a block diagram illustrating an overall configuration example of a communication system 10.

The communication system 10 includes an MFP 100, a terminal 200, and an access point (AP) 300.

Although FIG. 1 illustrates a configuration including three MFPs 100 and two terminals 200, the number of MFPs 100 and terminals 200 can be set to any number. For example, it is allowable to provide one or more MFPs 100 and one or more terminals 200.

The MFP 100 and the AP 300 are connected to a wired network. The terminal 200 can access the MFP 100 through the AP 300.

The MFP 100 is used as a multifunction device having a plurality of functions such as a print function of printing on a sheet, a document conveyance function to sequentially convey a plurality of documents, a communication function to transmit UI data (example of screen data) to the terminal 200, and an image reading function of reading an image of the conveyed document. The MFP 100 can operate in two states, a normal state and a power saving state. The normal state is a state in which power is supply to individual functions, enabling immediate start of processing as soon as an instruction such as printing is made. The power saving state is also referred to as a sleep state, which is a state in which power is supplied only to minimum functions of the MFP 100. When an operation screen acquisition request is issued from the terminal 200 or the like through the wired interface (I/F), the MFP 100 supplies power to individual functions and shifts from the power saving state to the normal state.

Examples of the terminal 200 include mobile terminals such as a tablet terminal, a smartphone, and a laptop computer (notebook PC). Alternatively, the terminal 200 may be a stationary personal computer (PC) such as a desktop computer device.

The terminal 200 displays an operation screen having a plurality of hierarchical structures for performing various settings for the MFP 100. This operation screen is displayed on the basis of UI data transmitted from the MFP 100. The hierarchical structure is a structure including a plurality of operation screens in stages. In a case where a next screen is displayed by user's operation of a button on the operation screen displayed on the terminal 200, the operation screen initially displayed on the terminal 200 is referred to as a first layer, and the next screen is referred to as a second layer. For example, a Scan menu setting screen corresponds to the first layer and a screen transitions from the screen after the button on the first layer is pressed (such as a screen for designating storage location of scanned data) corresponds to the second layer. In addition, a screen having a button for instructing the MFP 100 to start a job is referred to as a lowest layer. In a case, however, as in the Copy menu setting screen, where there is one layer alone with no next screen to which transition is possible, the Copy menu setting screen itself includes a button to instruct start of copying.

The AP 300 is connected to the terminal 200 via a wireless network such as a wireless local area network (LAN). When connected to the AP 300 via a wireless network, the terminal 200 is capable of performing data communication with each of the MFP 100 connected to the wired network.

### Block Diagram Illustrating Internal Configuration Example of MFP

FIG. 2 is a block diagram illustrating an internal configuration example of the MFP 100.

The MFP 100 includes a UI generator 100a, a UI transmitter 100b, a UI transmission controller 100c, a storage 100d, an MFP controller 100e, a power supply controller 100f, and a network part 100g.

The UI generator 100a is an example of a screen data generator, and generates UI data for configuring an operation screen or the like that can be displayed on the terminal 200. The UI generator 100a generates UI data in which link information for specifying a screen to which transition is performed by operation on the operation screen displayed on the terminal 200 is changed to link information that can be referred to on the terminal 200. However, the UI generator 100a does not change link information for which an execution instruction is issued to an own apparatus by operation on the operation screen, or does not change the link information included in a lowest layer of the operation screen having a hierarchical structure.

The UI transmitter 100b is an example of a screen data transmitter, and transmits the UI data generated by the UI generator 100a to the terminal 200 by network communication via the network part 100g.

The UI transmission controller 100c, an example of a screen data transmission controller, determines whether to perform preliminary transmission of the UI data for which acquisition request has been received from the terminal 200, and in a case where it determines that the preliminary transmission is necessary, notifies the terminal 200 that preliminary transmission of the UI data is to be performed. Subsequently, the UI transmission controller 100c instructs the UI generator 100a to generate the UI data to be transmitted in preliminary transmission.

Furthermore, the UI transmission controller 100c instructs the UI transmitter 100b to perform preliminary transmission of the UI data generated by the UI generator 100a, and notifies the power supply controller 100f that the power supply state can be shifted to the power saving state. With this operation, the UI transmission controller 100c shifts the power supply controller 100f to the power saving state.

Note that the UI transmission controller 100c can also determine whether to allow the UI transmitter 100b to perform preliminary transmission in accordance with the UI data type requested from the terminal 200.

In this manner, the UI transmission controller 100c has a function of collectively transmitting the necessary UI data in preliminary transmission in accordance with the request for UI data from the terminal 200, rather than transmitting the UI data every time the UI data request is received from the terminal 200, as in the conventional method. Additionally, the terminal 200 is notified that the preliminary transmission is to be performed. With this configuration, the MFP 100 can shift to the power saving state while the user is operating the UI data transmitted to the terminal 200 in preliminary transmission.

The UI transmission controller 100c also instructs the UI transmitter 100b to perform preliminary transmission of the UI data that is related to the function requested through the operation screen displayed on the terminal 200 and that is frequently operated by the terminal 200. For example, UI data of the next screen to which the operation screen displayed on the terminal 200 is to transition is transmitted in preliminary transmission in order to cause the MFP 100 to execute a function used by a general user to operate the operation screen. Here, a menu screen set by the administrator when operating the operation screen is used less frequently than the operation screen used by a general user. For this reason, there would be no influence on the operability even if the UI data of the menu screen such as the administrator setting is not transmitted as preliminary transmission.

The storage 100d includes a hard disk drive (HDD), and stores programs such as UI data, print data, network address information and device information, and image data that has undergone image formation processing. That is, the storage 100d can store the UI data transmitted in preliminary transmission by the UI transmitter 100b, the terminal 200 as a transmission destination of the UI data, and an access state from the terminal 200.

The MFP controller 100e has a copying function (Copy) of copying a document image, a reading function (Scan) of reading a document image, a facsimile function (Fax) of transmitting and receiving image data via a communication line, and a printing function (Print) of printing on the basis of image data supplied from an external device via an external I/F.

The power supply controller 100f controls a power supply state of the MFP 100 (own apparatus). The power supply controller 100f controls the power supplied to the MFP 100 and shifts the power supply state to either the normal state or the power saving state in which the power consumption is lower than that in the normal state. Since the power saving state includes a plurality of states, the power saving state to which the power supply state is shifted by the power supply controller 100f corresponds to one state selected from the plurality of states.

The network part 100g includes a network interface card (NIC) and a modem and performs network communication with the terminal 200 on which operation is performed for the own apparatus. The network part 100g enables data communication such as transmission of the UI data to the terminal 200 via the wired network and the wireless network and or reception of instructions from the terminal 200.

### Operation Example of Communication System

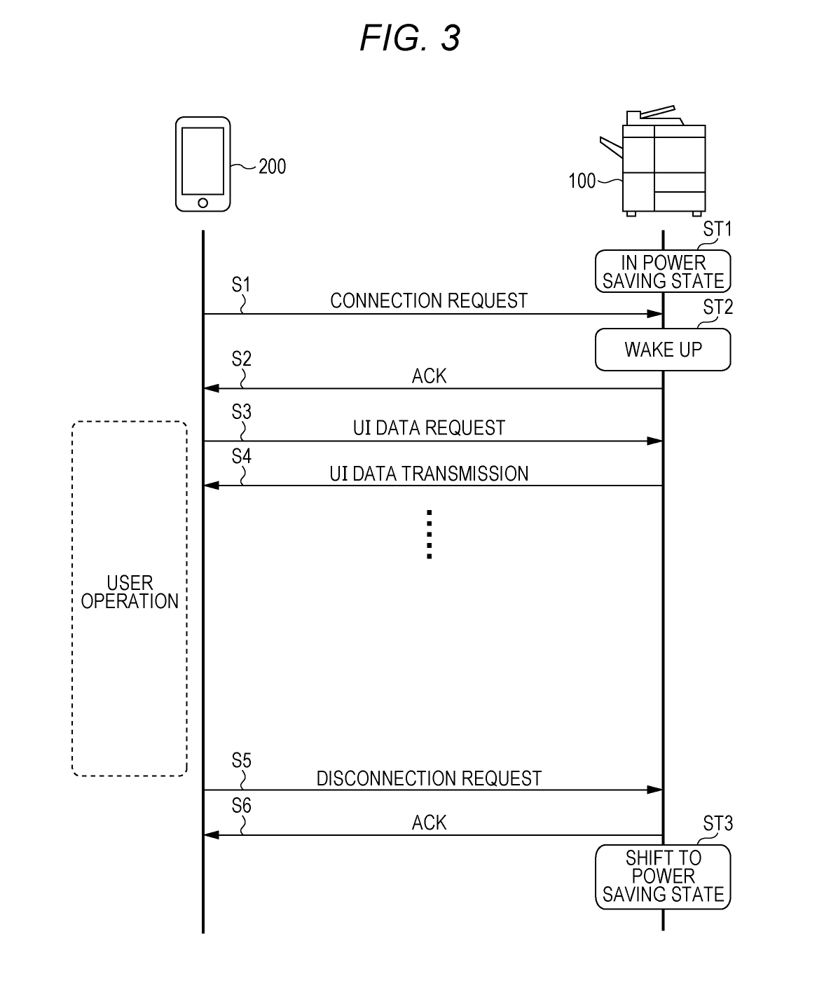

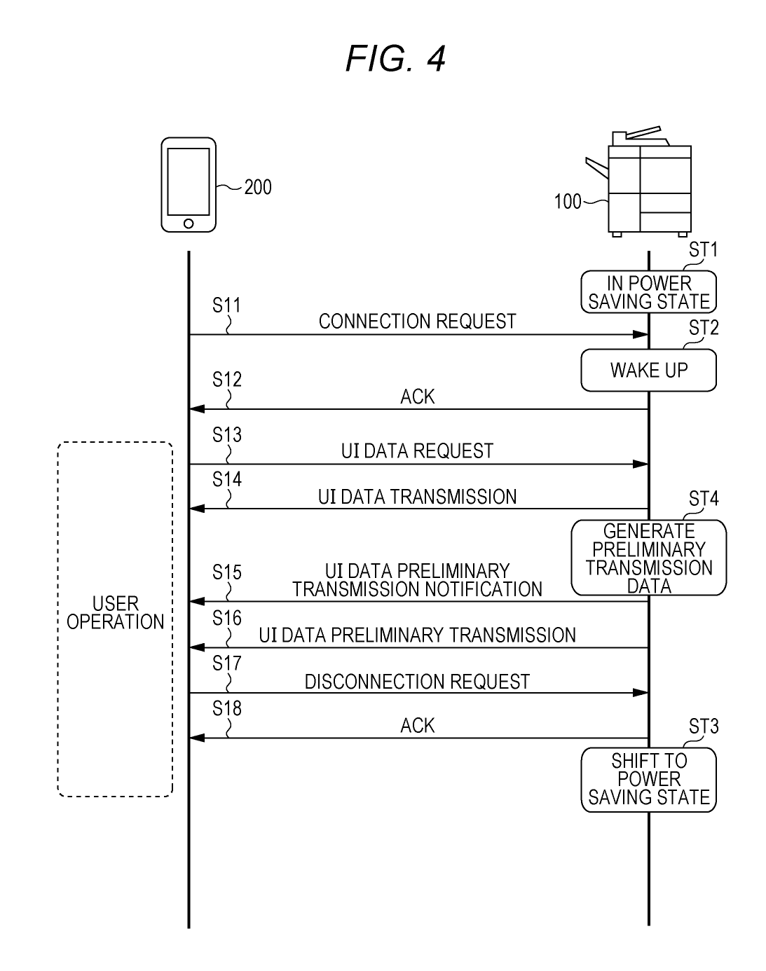

Next, an operation example of a conventional communication system and an operation example of the communication system 10 according to the present embodiment related to transmission of UI data will be described with reference to FIGS. 3 and 4.

FIG. 3 is a sequence diagram illustrating an operation example of the conventional communication system.

The conventional MFP can wirelessly communicate with the terminal In a case where Print or the like is executed on the MFP, a Print request is transmitted from a terminal connected via a wireless network to the MFP via an AP to instruct Print. This data exchange uses transmission control protocol (TCP), for example.

Initially, the terminal transmits a connection request (SYN packet) for requesting data transfer to an MFP being in a power saving state ST1 (S1).

The MFP that has received the connection request from the terminal shifts to a wake-up state ST2. Subsequently, the MFP transmits an ACK packet (acknowledgment) to the terminal to permit connection from the terminal (S2) and establishes a session with the terminal that has received a connection permission.

Next, the terminal and the MFP start transmitting and receiving the UI data. For example, the terminal requests (S3) the MFP in the wake-up state ST2 to provide UI data capable of displaying a Scan menu screen for performing Scan setting. The MFP transmits the requested UI data to the terminal (S4).

One set of exchanges of the processing of requesting a UI data request made by the terminal (S3) and the processing of UI data transmission from the MFP (S4) is performed to display the Scan menu screen for one page on the terminal. Here, the Scan menu screen includes buttons for transitioning to another screen, or the like. For example, in a case where the user operating the terminal has pressed the button, the terminal requests MFP to provide UI data of the next screen to be displayed on the terminal on the basis of the link information set on the button (S3). The MFP transmits the requested UI data of the next screen to the terminal (S4). The processing of requesting the UI data made by the terminal (S3) and the processing of transmitting the UI data from the MFP (S4) are repeated up to the layer other than the lowest layer, for example.

When the setting of the Scan is finished and there is no UI data request processing (S3) from the terminal, a session disconnect request is issued from the terminal to the MFP (S5). After receiving the disconnect request, the MFP transmits an ACK packet (acknowledgment) to the terminal (S6) and disconnects the session. Thereafter, the MFP shifts to a power saving state ST3.

In this manner, the conventional communication system performs request and transmission of UI data for each of screens displayed on the terminal. Therefore, the MFP needs to maintain the normal state so as to be able to transmit the UI data immediately since the timing of receiving the UI data request from the terminal is not fixed.

FIG. 4 is a sequence diagram illustrating an operation example of the communication system 10 according to the first embodiment of the present invention.

Similarly to the operation example of the conventional communication system in FIG. 3, the terminal 200 according to the first embodiment of the present invention also transmits a connection request to the MFP 100 in a power saving state ST1 (S11). Then, after shifting the MFP 100 to a wake-up state ST2, a session is established (S12) on reception of an ACK packet (acknowledgment) from the MFP 100.

In addition, the terminal 200 requests (S13) the MFP 100 in the wake-up state ST2 to provide UI data capable of displaying a Scan menu screen for performing Scan setting. The MFP 100 transmits the requested UI data to the terminal (S14). After the session is established between the terminal 200 and the MFP 100, the MFP 100 shifts to a state ST4 of generating UI data to be transmitted in preliminary transmission to the terminal 200.

The UI data transmitted in preliminary transmission by the MFP 100 includes, for example, UI data for displaying on the terminal 200 a screen to which transition from the Scan menu screen is possible. The data amount of UI data to be transmitted in preliminary transmission is larger than the amount of UI data transmitted to the conventional terminal illustrated in FIG. 3. Therefore, the UI transmission controller 100c notifies the terminal 200 that the UI data is to be transmitted in preliminary transmission (S15). Upon receiving this notification, the terminal 200 reserves a storage region in the terminal 200.

After transmitting notification to the terminal 200, the MFP 100 transmits the UI data in preliminary transmission to the terminal 200 (S16). The terminal 200 saves the UI data transmitted in preliminary transmission from the MFP 100 in the storage region in the terminal 200.

The link information included in the UI data transmitted in preliminary transmission by the MFP 100 has been changed by the UI transmission controller 100c to the link information that can be referred to within the terminal 200 so as to enable the terminal 200 to transition to the next screen without communicating with the MFP 100 via the network part 100g. This enables the terminal 200 to display, for example, the next screen to which transition is performed from the Scan menu screen by merely referring to the UI data transmitted in preliminary transmission by the MFP 100, stored in the storage region in the terminal 200. After the MFP 100 transmits the UI data in preliminary transmission to the terminal 200, the MFP 100 does not need to maintain the normal state until the terminal 200 instructs the MFP 100 to execute operation.

Therefore, after step S16, a session disconnect request is issued from the terminal 200 to the MFP 100 (S17). After receiving the disconnection request, the MFP 100 transmits an ACK packet (acknowledgment) to the terminal and disconnects the session (S18). Thereafter, the MFP shifts to a power saving state ST3.

In this manner, since the UI data is transmitted in preliminary transmission in the processing of the terminal 200 and the MFP 100 illustrated in FIG. 4, the MFP 100 shifts to the power saving state ST3 in a shorter time as compared with the processing of the conventional terminal and the MFP illustrated in FIG. 3.

### Operation Example of Communication System Between Terminal and MFP (With a Home Screen)

Next, an operation example of the terminal and the MFP in a case where there is a home screen on the operation screen displayed on the terminal will be described.

The home screen is a screen displayed before the transition to the operation screen on which the user operating the terminal 200 performs execution instructions such as Print, Copy, Scan, etc. to the MFP 100. The home screen may have different specifications for each of organizations to which the user belongs. For example, a logo of the organization to which the user belongs may be displayed on the home screen. Here, description of the operation example of the conventional communication system is omitted.

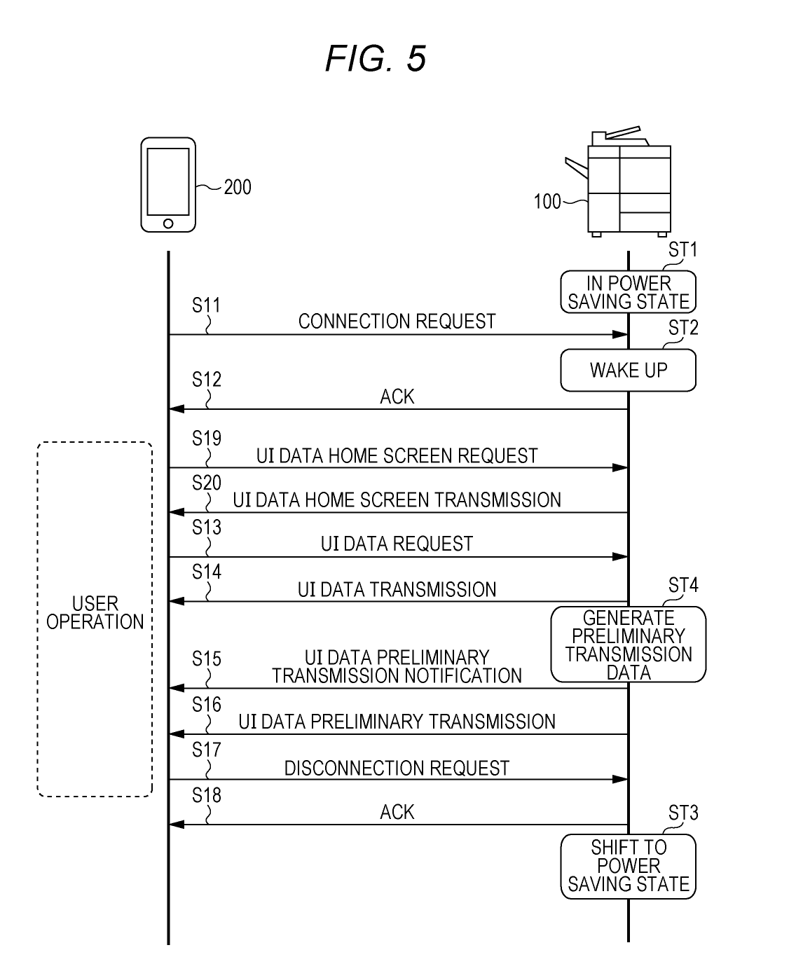

FIG. 5 is a sequence diagram illustrating an operation example when the MFP 100 transmits the home screen to the terminal 200. In the operation example illustrated in FIG. 5, processing of requesting and transmitting UI data of the home screen is added between steps S12 and S13 illustrated in FIG. 4.

The processing of steps S11 and S12 illustrated in FIG. 5 is as described in FIG. 4. Then, after the MFP 100 wakes up and establishes a session with the terminal 200, the terminal 200 requests the MFP 100 to transmit the UI data of the home screen (S19). The MFP 100 generates UI data of a home screen that can be displayed on the terminal 200, and transmits the generated UI data to the terminal 200 (S20). With this operation, the home screen is displayed on the terminal 200.

The home screen displays buttons to be used to transition to the menu screen including Copy setting, Scan setting, and administrator setting. The user operating the terminal 200 can make settings for the MFP 100 by selecting any of the buttons. At a timing when the user presses the button, the terminal 200 requests (S13) the MFP 100 in the wake-up state ST2 to provide UI data capable of displaying a Scan menu screen on which Scan setting is performed. The MFP 100 transmits the requested UI data to the terminal (S14). With this operation, the Scan menu screen is displayed on the terminal 200. Then, processing from step S15 onward is performed similarly to FIG. 4.

There are various types of menu screens transitioned from the home screen, and it is often unknown which menu is to be selected by the user. Therefore, the MFP 100 transmits the UI data of the home screen to the terminal 200 before transmitting the UI data of the menu screen. However, execution of preliminary transmission for the UI data related to the entire menu screen to the terminal 200 together with the home screen in accordance with the menu that the user can select might cause not only shortage of the communication band of the wired network but also the shortage of the storage region of the terminal 200.

To manage this, in a case where the terminal 200 requests the UI data of the home screen, the MFP 100 transmits the UI data of the home screen alone to the terminal 200. Thereafter, on the basis of the button selected from the home screen displayed on the terminal 200, the MFP 100 collectively transmits the UI data of the menu screen in preliminary transmission This makes it possible to avoid shortage both in the communication band of the wired network and the storage region of the terminal 200.

### Processing Example of MFP

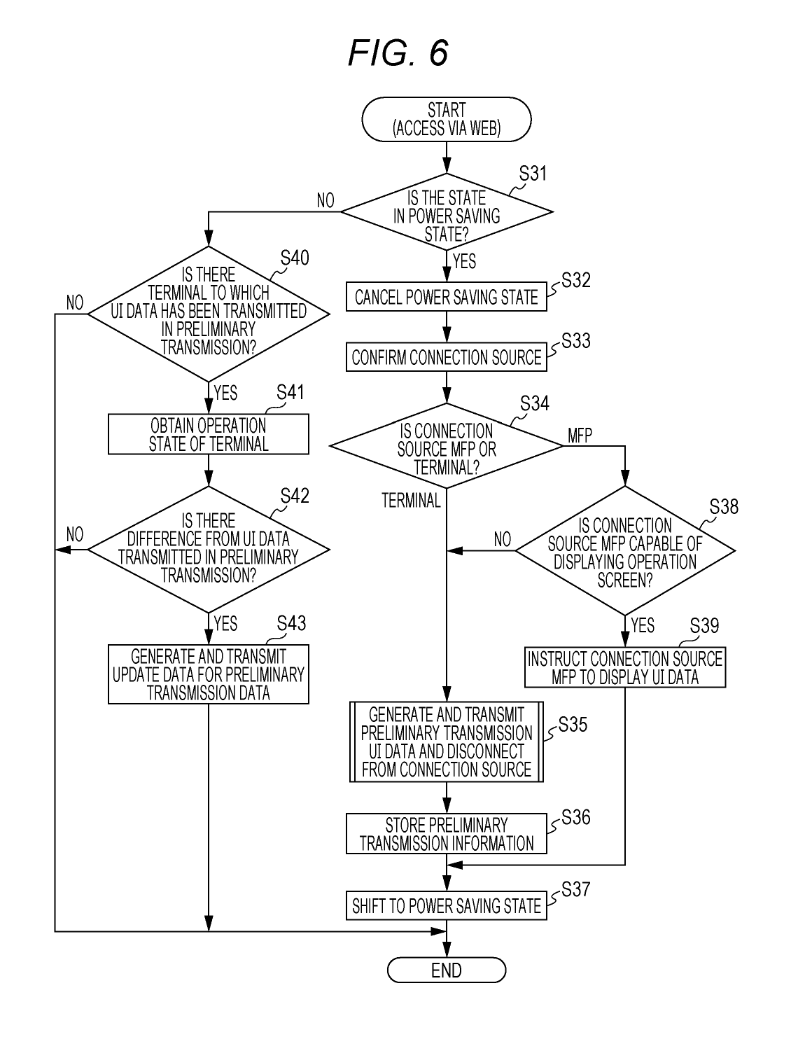

FIG. 6 is a flowchart illustrating a processing example of the MFP 100 according to the first embodiment of the present invention.

Hereinafter, processing of UI data that the UI transmission controller 100c transmits to the terminal 200 in preliminary transmission in a case where the terminal 200 accesses via the web to the MFP 100 and requests the MFP 100 to provide the UI data will be described.

First, the UI transmission controller 100c determines whether the MFP 100 is in the power saving state (S31). When the UI transmission controller 100c determines that the MFP 100 is in the power saving state (Yes in S31), the UI transmission controller 100c cancels the power saving state of the MFP 100 (S32). Thereafter, the UI transmission controller 100c confirms the connection source of the MFP 100 (S33).

The UI transmission controller 100c determines which of the MFP 100 and the terminal 200 is the connection source of the MFP 100 (S34). In steps S33 and S34, the UI transmission controller 100c obtains information related to the device type from the connection source, and switches the necessity of execution of preliminary transmission to the connection source of the UI data in accordance with the device type of the connection source.

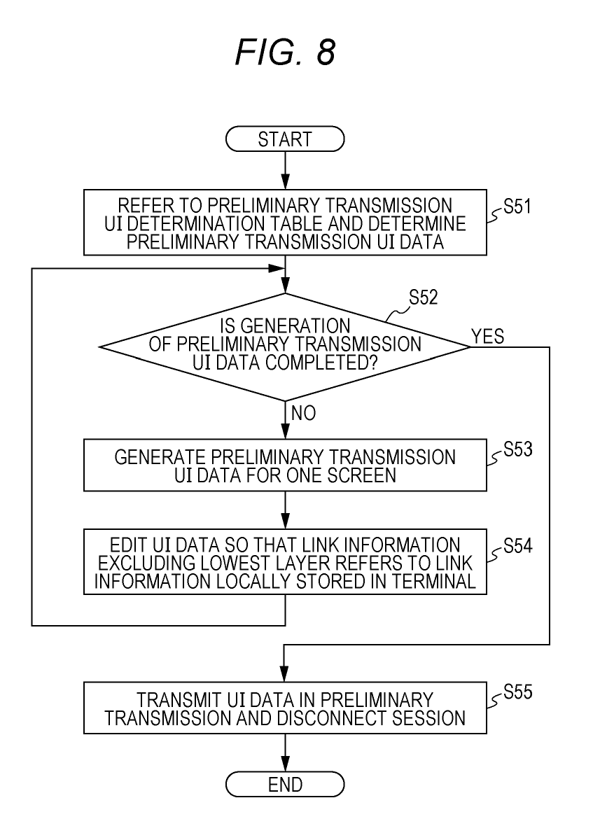

In a case where it is determined that the connection source is the terminal 200 (terminal of S34), the UI transmission controller 100c instructs the UI generator 100a to generate UI data to be transmitted in preliminary transmission to the terminal 200, and instructs the UI transmitter 100b to transmit the generated UI data. The UI transmission controller 100c confirms that the UI data generated by the UI generator 100a has been transmitted to the terminal 200 via the network part 100g by the UI transmitter 100b and then disconnects the session with the terminal 200 (S35). Detailed processing of step S35 will be described below with reference to FIG. 8.

Next, the UI transmission controller 100c stores the UI data transmitted in preliminary transmission and the terminal 200 as a transmission destination, into the storage 100d (S36). Thereafter, the UI transmission controller 100c performs control to instruct the power supply controller 100f to shift to the power saving state (S37), so as to finish the present processing. Then, the MFP 100 is controlled by the power supply controller 100f to shift to the power saving state.

Meanwhile, in a case where it is determined in step S34 that the connection source is the MFP 100 (MFP in S34), the UI transmission controller 100c determines whether the connection source MFP 100 can display the operation screen (S38). This determination is performed in consideration of a case where there is no need to transmit the UI data to the connection source MFP 100. For example, if the connection source MFP 100 itself stores the screen data of the home screen and the menu screen and is capable of display the home screen and the menu screen, the UI transmitter 100b need not transmit the UI data to the connection source MFP 100.

In a case where it is determined that the connection source MFP 100 can display the operation screen (Yes in S38), the UI transmission controller 100c instructs the connection source MFP 100 to display the UI data (S39), and the processing proceeds to step S37. Accordingly, the UI transmitter 100b does not transmit the UI data to the connection source MFP 100. Thereafter, the processing of the above-described step S37 onward is performed.

In a case where the UI transmission controller 100c determines that the connection source MFP 100 cannot display the operation screen (No in S38), the processing proceeds to step S35. Thereafter, the processing from step S35 onward is performed.

Meanwhile, in a case where it is determined in step S31 that the MFP 100 is not in the power saving state (No in S31), the UI transmission controller 100c refers to the storage 100d and determines whether there is a terminal 200 to which UI data has already been transmitted in preliminary transmission (S40). In a case where there is no terminal 200 that has received the UI data transmitted in preliminary transmission (No in S40), the present processing is finished.

In contrast, in a case where there is a terminal 200 to which the UI data has already been transmitted in preliminary transmission (Yes in S40), the UI transmission controller 100c obtains the operation state of the terminal 200 (S41).

Next, the UI transmission controller 100c determines whether a difference has occurred with the UI data already transmitted in preliminary transmission to the terminal 200, caused by update of the UI data by the UI generator 100a during the period of the power saving state of the MFP 100 (S42).

In a case where the UI transmission controller 100c determines that a difference has occurred with the UI data transmitted in preliminary transmission and stored in the terminal 200 as a result of update of the UI data performed by the UI generator 100a (Yes in S42), the UI transmission controller 100c causes the UI generator 100a to generate update data for updating the UI data transmitted in preliminary transmission, and transmits the generated update data to the terminal 200 (S43). At this time, the UI transmission controller 100c also transmits to the terminal 200 a discard request for the UI data that has been transmitted in preliminary transmission, and then finishes the present processing.

In contrast, in a case where the UI transmission controller 100c determines that there is no difference from the UI data transmitted in preliminary transmission and stored in the terminal 200 (No in S42), the UI transmission controller 100c finishes the present processing at this stage since there is no need to update the UI data transmitted in preliminary transmission in the terminal 200.

### Example of Processing of Generating and Transmitting Preliminary Transmission UI Data

Next, details of the processing of determining the UI data to be transmitted in preliminary transmission and causing the UI transmitter 100b to perform preliminary transmission of the UI data performed by the UI transmission controller 100c will be described.

The MFP 100 can judge necessity of execution of preliminary transmission of the UI data in accordance with the menu screen requested from the terminal 200.

For example, in a case where UI data on the Copy menu screen is requested from the terminal 200, it is highly likely that the terminal 200 immediately requests execution of copy to the MFP 100.

At this time, a fixing unit (not illustrated) provided in the MFP 100 takes a certain time to warm up. Accordingly, the MFP 100 starts warming up the fixing unit immediately after transmitting the UI data of the Copy menu screen to the terminal 200.

With this configuration, the MFP 100 can immediately execute copy in response to the request of execution of copy received from the terminal 200. For this reason, the user operating the terminal 200 does not need to wait for the time until the MFP 100 actually starts copying after instruction to start copying made on the Copy menu screen. In this manner, the UI transmission controller 100c can perform control that does not perform preliminary transmission of the UI data by prioritizing the convenience of the user.

In contrast, when the menu screen requested from the terminal 200 is the administrator menu screen, it is highly likely that setting change alone is to be performed onto the MFP 100. Therefore, with the preliminary transmission of the UI data of the menu screen to the terminal 200 by the UI transmission controller 100c, the MFP 100 does not have to maintain the normal state until the setting change is instructed from the terminal 200.

This enables prompt shift of the power supply controller 100f to the power saving state. The MFP 100 is only required to wake up and change the setting after reception of a setting change instruction from the terminal 200.

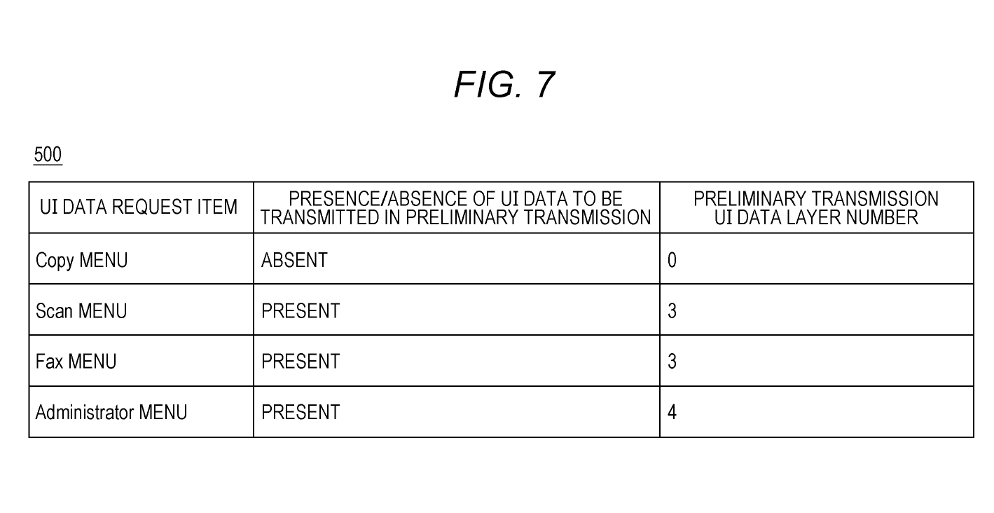

A configuration example of the preliminary transmission UI data determination table 500 referred to by the UI transmission controller 100c when it determines necessity of execution of preliminary transmission of the UI data will be described with reference to FIG. 7.

FIG. 7 is a table illustrating a configuration example of the preliminary transmission UI data determination table 500.

The preliminary transmission UI data determination table 500 is a table stored in the storage 100d, for example. The preliminary transmission UI data determination table 500 includes a UI data request item field, a preliminary transmission UI data presence/absence field and a preliminary transmission UI data layer number field.

The UI data request item field stores information specifying the menu screen at the time of execution of UI data acquisition request from the terminal 200 to the MFP 100. While the information specifying the menu screen may be represented by the screen name, the screen identifier, or the like, here, it is represented by the screen name like the Copy menu, the Scan menu, the Fax menu and the administrator menu.

The preliminary transmission UI data presence/absence field stores information indicating the presence or absence of UI data that the MFP 100 transmits to the terminal 200 in preliminary transmission.

The preliminary transmission UI data layer number field stores information indicating the number of hierarchical layers in the next and subsequent screens to which transition is performed from the menu screen.

Since Copy menu of the UI data request item field has no next screen to which transition is performed other than the copy execution instruction, “No” is stored in the preliminary transmission UI data presence/absence field, while “0” is stored in the preliminary transmission UI data layer number field.

In contrast, the Scan menu, the Fax menu, and the administrator menu in the UI data request item field transition to their individual next and subsequent screens in response to button operation. Accordingly, for any menu, “Present” is stored in the preliminary transmission UI data presence/absence field. The preliminary transmission UI data layer number field stores “3” for the Scan menu, “3” for the Fax menu, and “4” for the administrator menu.

Note that the preliminary transmission UI data layer number field does not include the lowest layer. In the setting of the preliminary transmission UI data, the lowest layer of the operation screen is set to normal UI data link information. Therefore, the lowest layer of the UI data remains the normal UI data link information, and thus, the terminal 200 communicates with the network part 100g when access is made to the UI data link information.

Next, processing of determining necessity of execution of UI data preliminarily transmission to be performed with reference to the preliminary transmission UI data determination table 500 will be described with reference to FIG. 8.

FIG. 8 is a flowchart illustrating a detailed example of the processing of generating and transmitting the preliminary transmission UI data illustrated in step S35 of FIG. 6.

As described above, the UI transmission controller 100c switches necessity of execution of transmission of preliminary transmission UI data in accordance with the UI data type requested from the terminal 200 (for example, Copy setting, Scan setting, Administrator setting).

In order to do this, the UI transmission controller 100c refers to the preliminary transmission UI data determination table 500 to determine UI data to be transmitted in preliminary transmission (S51), and determines whether the UI generator 100a has been generated the preliminary transmission UI data (S52).

In a case where the UI generator 100a determines that the UI data to be transmitted in preliminary transmission has been generated (Yes in S52), the UI transmission controller 100c transmits the UI data in preliminary transmission to the terminal 200, disconnects the session with the terminal 200 (S55) to finish the present processing.

In a case where the UI generator 100a determines that the preliminary transmission UI data has not been generated (No in S52), the UI transmission controller 100c causes the UI generator 100a to generate the menu screen of the preliminary transmission UI data alone (S53). Subsequently, the UI transmission controller 100c edits the UI data so that the link information excluding the lowest layer refers to the link information stored in the storage region in the terminal 200 (S54).

Thereafter, when it is determined that the preliminary transmission UI data has been successfully generated in step S52 (Yes in S52), the UI transmission controller 100c transmits the UI data in preliminary transmission to the terminal 200, disconnects the session with the terminal 200 (S55) to finish the present processing.

### Example of Link Information Change

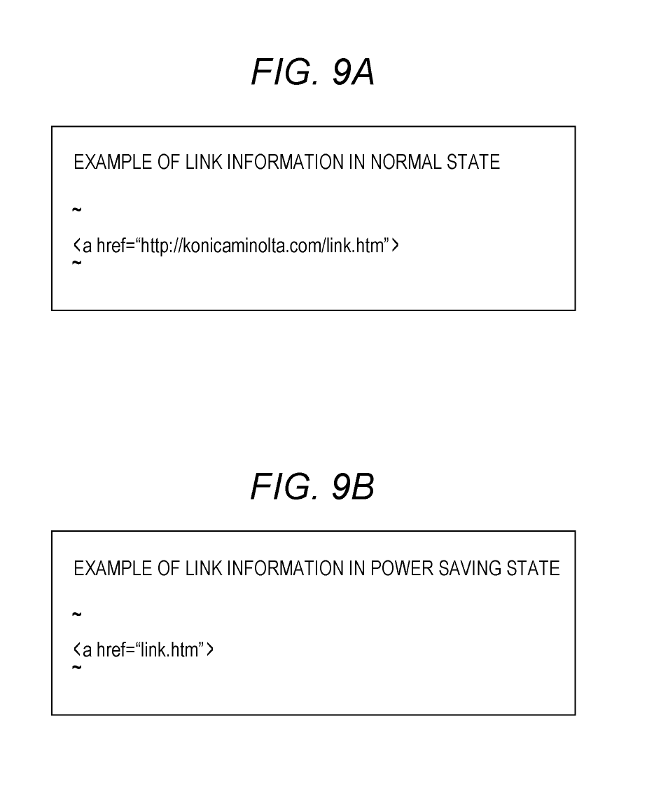

FIGS. 9A and 9B are explanatory diagrams illustrating examples of link information set in the UI data.

FIG. 9A illustrates an example of the link information set in the UI data in a case where the UI data is obtained by accessing the MFP 100 for each of screen transitions on the terminal 200.

This UI data has setting, for example, of link information used by the terminal 200 to gain access via the web to the htm file stored in the MFP 100.

This link information is expressed as “<a href=“http://konicaminolta.com/link htm”>”, for example.

FIG. 9B illustrates an example of the link information set in the UI data transmitted in preliminary transmission to the terminal 200.

This UI data has setting, for example, of link information changed so as to refer to the htm file stored in the storage region of the terminal 200.

This link information is expressed as “<a href=“link.htm”>”, for example.

In the communication system 10 according to the first embodiment described above, in a case where the terminal 200 gains access via the web to the MFP 100 in the power saving state, the MFP 100 follows the menu screen operated on the terminal 200 to generate a set of UI data related to the menu screen and transmits the generated UI data in preliminary transmission to the terminal 200. With this configuration, unlike the conventional case, the MFP 100 does not need to maintain the normal state in preparation for access from the terminal 200. Furthermore, after performing preliminary transmission of the screen data to the terminal 200, the MFP 100 disconnects the session and immediately shifts to the power saving state. In this manner, while performing operation or setting for the MFP 100 on the terminal 200, the MFP 100 can return to the power saving state, making it possible to enhance the power saving effect.

The UI data transmitted in preliminary transmission to the terminal 200 is related to the function requested from the terminal 200 and is frequently operated by the terminal 200. Therefore, the user operating the terminal 200 can operate the operation screen displayed in response to the reception of the UI data by the terminal 200 so as to promptly execute target functions.

### Modification of First Embodiment

The preliminary transmission of UI data includes various methods.

For example, when there is previous access from the terminal 200 to the MFP 100 (own apparatus) and the MFP 100 wakes up from the power saving state, the UI transmission controller 100c confirms necessity of execution of additional transmission to the UI data transmitted in preliminary transmission to the terminal 200, and transmits, in additional transmission, the UI data for which necessity of additional transmission has been confirmed from the terminal 200. With this arrangement, the MFP 100 in the wake-up state can transmit the necessary UI data in additional transmission to the terminal 200 when it is insufficient with the UI data transmitted in preliminary transmission alone.

Furthermore, in a case where there is previous access to the MFP 100 (own apparatus) from another terminal 200 and the MFP 100 wakes up from the power saving state, the UI transmission controller 100c returns link information that has been changed to link information that can be referred to within the terminal 200, to the link information that can be accessed via the web. Subsequently, the UI transmission controller 100c notifies the terminal 200 that the link information changed to the link information that can be referred to within the terminal 200 is going to be returned to link information that can be accessed via the web, and also transmits the terminal 200 the link information that can be accessed via the web. With this configuration, the MFP 100 in the wake-up state can transmit the UI data to the terminal 200 in accordance with the access from the terminal 200 via the web similarly to the conventional method.

Alternatively, the UI transmission controller 100c may cause the UI transmitter 100b in step S3 to perform preliminary transmission of the UI data changed in accordance with the information related to restriction of the preliminary transmission UI data, which is received from the terminal 200. For example, when the storage region of the terminal 200 is tight, the UI transmission controller 100c can perform preliminary transmission of the UI data with the reduced number of layers or even cancel the preliminary transmission of the UI data.

### Example of Overall Configuration of Communication System According to Second Embodiment

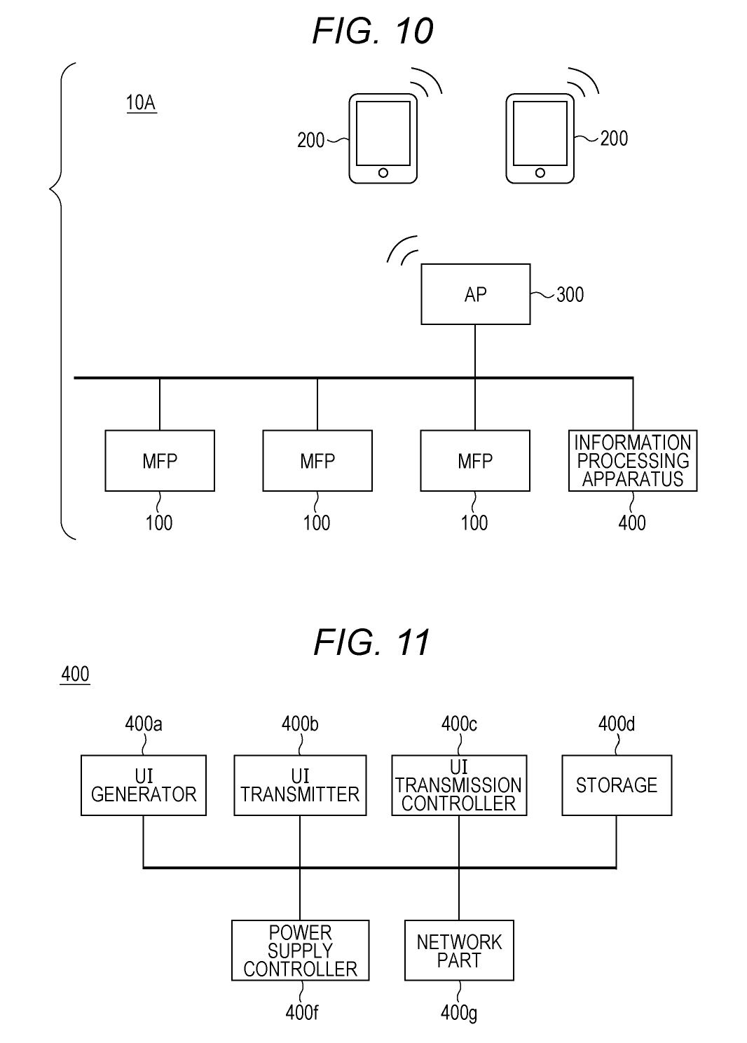

Next, a communication system according to a second embodiment of the present invention will be described with reference to FIGS. 10 to 12.

FIG. 10 is a block diagram illustrating an example of an overall configuration of a communication system 10A.

The communication system 10A includes the MFP 100, the terminal 200, the AP 300, and an information processing apparatus 400. The information processing apparatus 400 is connected to a wired network to which the MFP 100 and the AP 300 are connected. Therefore, the MFP 100 can access the information processing apparatus 400. The communication system 10A has a server client configuration having the information processing apparatus 400 as a server and the MFP 100 as a client.

The information processing apparatus 400 is a server apparatus, for example, and has a communication function for transmitting and receiving UI data, a storage function of storing a variety of information, or the like. In a case where the MFP 100 has an image forming function alone, the information processing apparatus 400 can generate the UI data instead of the MFP 100 and can transmit the UI data in preliminary transmission to the MFP 100.

### Example of Internal Configuration of Information Processing Apparatus According to Second Embodiment of The Present Invention

FIG. 11 is a block diagram illustrating an internal configuration example of the information processing apparatus 400.

The information processing apparatus 400 includes a UI generator 400a, a UI transmitter 400b, a UI transmission controller 400c, a storage 400d, a power supply controller 400f, and a network part 400g. The functions of the individual components of the information processing apparatus 400 are similar to the functions of the individual components of the MFP 100 illustrated in FIG. 2 described above. Main functions and operation examples of each of functional blocks included in the information processing apparatus 400 will be described below.

The UI generator 400a generates UI data for configuring an operation screen or the like that can be displayed by the MFP 100 during access to the information processing apparatus 400. The UI generator 400a generates UI data in which link information for specifying a screen to which transition is performed by operation on the operation screen displayed on the MFP 100 is changed to link information that can be referred to on the MFP 100.

The UI transmitter 400b transmits the UI data generated by the UI generator 400a to the MFP 100 using network communication via the network part 400g.

The UI transmission controller 400c determines whether to perform preliminary transmission of the UI data for which an acquisition request has been received from the MFP 100. In a case where the UI transmission controller 400c determines that preliminary transmission is necessary, the UI transmission controller 400c notifies the MFP 100 that preliminary transmission of the UI data is to be performed, and instructs the UI generator 400a to generate preliminary transmission UI data. Furthermore, the UI transmission controller 400c instructs the UI transmitter 400b to perform preliminary transmission of the UI data generated by the UI generator 400a, and notifies the power supply controller 400f that the power supply state can be shifted to the power saving state, so as to control the power supply controller 400f to shift the power supply state to the power saving state.

The storage 400d can store the UI data transmitted in preliminary transmission by the UI transmitter 400b, the MFP 100 as a transmission destination of the UI data, and an access state from the MFP 100.

The power supply controller 400f controls the power supply state of the information processing apparatus 400 (own apparatus). The power supply controller 100f controls the power supplied to the information processing apparatus 400 and shifts the power supply state to either the normal state or the power saving state in which the power consumption is lower than that in the normal state.

The network part 400g includes an NIC, a modem, or the like, and performs network communication with the MFP 100 on which operation is performed for the information processing apparatus 400 (own apparatus). The network part 400g can perform data communication such as transmission of UI data to the MFP 100 or reception of instructions from the MFP 100, via a wired network.

### Example of Operation of Communication System Between MFP and Information Processing Apparatus>

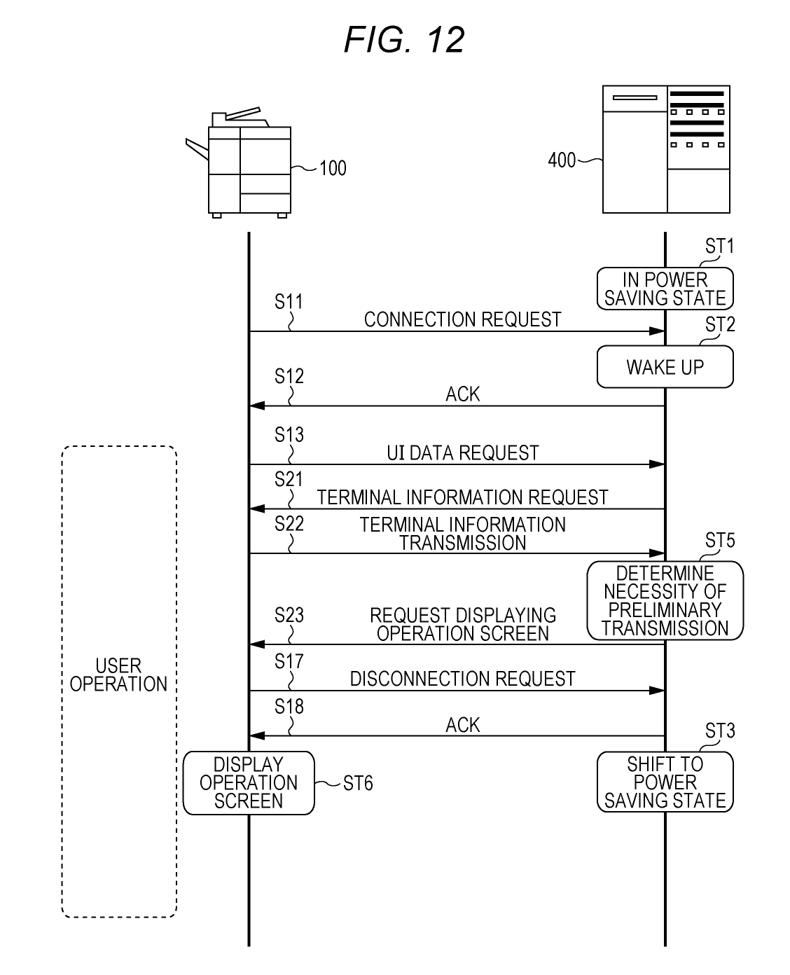

FIG. 12 is a sequence diagram illustrating an operation example of the communication system 10A. In the second embodiment of the present invention, the information processing apparatus 400 transmits the UI data in preliminary transmission to the MFP 100 capable of displaying the operation screen. In the operation example illustrated in FIG. 12, steps S12 and S13 illustrated in FIG. 4 are followed by additional processing of requesting terminal information for identifying the MFP 100 and transmission thereof, and processing of switching necessity of execution of preliminary transmission in accordance with the connection source type.

The processing in steps S11 to S13 illustrated in FIG. 12 is as described in FIG. 4. When the information processing apparatus 400 wakes up to establish a session with the MFP 100, the MFP 100 requests the information processing apparatus 400 to transmit the UI data in preliminary transmission (S13).

The information processing apparatus 400 requests the MFP 100 of the connection source to transmit terminal information in order to specify the type of the MFP 100 (S21). In response to this, the MFP 100 transmits the terminal information to the information processing apparatus 400 (S22). On the basis of this information, the UI transmission controller 100c of the information processing apparatus 400 determines whether UI data to be transmitted in preliminary transmission to the MFP 100 is necessary (ST5).

In a case where UI data is stored in the MFP 100, preliminary transmission of UI data from the information processing apparatus 400 to the MFP 100 is unnecessary. Therefore, the information processing apparatus 400 requests the operation screen to be displayed using the UI data held by the MFP 100 (S23). In contrast, in a case where the UI data is not stored in the MFP 100, the information processing apparatus 400 transmits the UI data in preliminary transmission to the MFP 100 and displays the operation screen on the MFP 100.

Thereafter, the information processing apparatus 400 disconnects the established session with the MFP 100. The processing after step S17 of disconnecting the session is as described with reference to FIG. 4. After the information processing apparatus 400 shifts to the power saving state ST3, the MFP 100 enters a state of displaying the operation screen (ST6).

In the communication system 10A according to the second embodiment described above, the information processing apparatus 400 generates the UI data to be transmitted in preliminary transmission, which is transmitted by the MFP 100 to the terminal 200 in the first embodiment, and transmits the generated UI data to the MFP 100 in preliminary transmission. With this configuration, the information processing apparatus 400 can immediately shift to the power saving state after performing preliminary transmission of the UI data.

Note that the information processing apparatus 400 can also perform preliminary transmission of the UI data requested from the terminal 200, to the terminal 200. In a case where the terminal 200 accesses the information processing apparatus 400, the operation performed by each of functional blocks in the information processing apparatus 400 illustrated in FIG. 11 onto the terminal 200 is similar to the operation performed by the information processing apparatus 400 onto the MFP 100.

Although embodiments of the present invention have been described and illustrated in detail, the disclosed embodiments are made for purposes of illustration and example only and not limitation. The scope of the present invention should be interpreted by terms of the appended claims Various other application examples and modifications can naturally be adopted as long as they do not deviate from the scope and spirit of the present invention described in the claims

For example, while the above-described embodiments gives detailed and specific description of the configuration of the apparatus and the system in order to clearly present the present invention, the present invention is not necessarily limited to the embodiments having all the configurations described. Furthermore, it is possible to replace a part of the configuration of the embodiment described here with the configuration of another embodiment, and furthermore, it is also possible to add a configuration of another embodiment to the configuration of one embodiment. Furthermore, it is also possible to add, delete, and replace a portion of other configurations with respect to part of the configuration of individual embodiments.

Moreover, control lines and information lines indicate what is considered to be necessary for explanation, and not necessarily include all control lines and information lines in the product. In practice, it can be considered that almost all the structures are mutually connected.

What is claimed is:

1. An image forming apparatus comprising:
a power supply controller that controls a power supply state of an own apparatus;
a network part that performs network communication with a terminal on which operation for the own apparatus is performed;
a screen data generator that generates screen data for configuring an operation screen displayed on the terminal;
a screen data transmitter that transmits the screen data to the terminal via the network communication; and
a screen data transmission controller that performs determination as to whether to perform preliminary transmission of the screen data for which an acquisition request has been received from the terminal, and
in a case where the screen data transmission controller determines that preliminary transmission is necessary,
the screen data transmission controller notifies the terminal that preliminary transmission of the screen data is to be performed, instructs the screen data generator to generate the screen data to be transmitted in preliminary transmission, instructs the screen data transmitter to perform preliminary transmission of the screen data generated by the screen data generator, and together with this, notifies the power supply controller that the power supply state can be shifted to a power saving state so as to cause the power supply controller to shift the power supply state to the power saving state.

2. The image forming apparatus according to claim 1,
wherein the screen data transmission controller instructs the screen data transmitter to perform preliminary transmission of the screen data that is related to the function requested through the operation screen displayed on the terminal and that is frequently operated by the terminal.

3. The image forming apparatus according to claim 1,
wherein the screen data generator generates the screen data in which link information for specifying a screen to which transition is performed by operation on the operation screen displayed on the terminal is changed to link information that can be referred to on the terminal.

4. The image forming apparatus according to claim 3,
wherein the screen data generator does not change link information for which an execution instruction is issued to the own apparatus by operation on the operation screen, or does not change the link information included in a lowest layer of the operation screen having a hierarchical structure.

5. The image forming apparatus according to claim 1,
wherein the screen data transmission controller determines whether to cause the screen data transmitter to perform preliminary transmission of the screen data in accordance with a type of the screen data requested from the terminal.

6. The image forming apparatus according to claim 1, further comprising a storage that stores the screen data transmitted in preliminary transmission by the screen data transmitter and that stores the terminal as a transmission destination of the screen data,
wherein in a case where there is a difference between the screen data transmitted in preliminary transmission by the screen data transmitter and screen data updated by the screen data generator,
the screen data transmission controller causes the screen data transmitter to transmit update data for updating the screen data that has been transmitted in preliminary transmission to the terminal as the transmission destination of the screen data, and causes the screen data transmitter to transmit a discard request for the screen data transmitted in preliminary transmission.

7. The image forming apparatus according to claim 6,
wherein the storage stores an access state from the terminal, and
in a case where there is previous access from the terminal to the own apparatus and the own apparatus wakes up from a power saving state,
the screen data transmission controller confirms necessity of execution of additional transmission to the screen data transmitted to the terminal in the preliminary transmission, and performs additional transmission of the screen data for which necessity of additional transmission has been confirmed from the terminal

8. The image forming apparatus according to claim 1, further comprising a storage that stores the screen data transmitted in preliminary transmission by the screen data transmitter, the terminal as a transmission destination of the screen data, and an access state from the terminal,
wherein in a case where there is previous access from the terminal to the own apparatus and the own apparatus wakes up from a power saving state,
the screen data transmission controller notifies the terminal that link information for specifying a screen to which transition is performed by operation on the operation screen displayed on the terminal by the screen data transmitted to the terminal in preliminary transmission is to be returned to link information that can be accessed via a web, the link information having been changed to the link information that can be referred to on the terminal, and together with this, transmits, to the terminal, the link information that can be accessed via the web.

9. The image forming apparatus according to claim 1,
wherein the screen data transmission controller causes the screen data transmitter to transmit, in preliminary transmission, the screen data that has been changed in accordance with information related to restriction on the screen data to be transmitted in preliminary transmission, received from the terminal.

10. The image forming apparatus according to claim 1,
wherein the screen data transmission controller obtains information related to a type of the terminal and switches necessity of execution of preliminary transmission of the screen data to the terminal in accordance with the type of the terminal

11. A non-transitory recording medium storing a computer readable program causing a computer to perform:
determining whether to perform preliminary transmission of screen data for configuring an operation screen displayed on a terminal on which operation for an own apparatus is performed, for which an acquisition request has been received from the terminal, to the terminal, and
in a case where it is determined that preliminary transmission is necessary,
notifying the terminal that preliminary transmission of the screen data is to be performed;
instructing a screen data generator that generates the screen data to generate the screen data to be transmitted in preliminary transmission;
instructing the screen data transmitter to perform preliminary transmission of the generated screen data so as to perform preliminary transmission of the screen data to the terminal via network communication; and
notifying a power supply controller that controls a power supply state of the own apparatus that it is possible to shift the power supply state of the own apparatus to a power saving state so as to cause the power supply controller to shift the power supply state to the power saving state.

12. An information processing apparatus comprising:
a power supply controller that manages and controls a power supply state of an own apparatus;
a network part that performs network communication from an image forming apparatus to the own apparatus;
a screen data generator that generates screen data for configuring an operation screen displayed on the image forming apparatus;
a screen data transmitter that transmits the screen data to the image forming apparatus via the network communication; and
a screen data transmission controller that performs determination as to whether to perform preliminary transmission of the screen data for which an acquisition request has been received from the image forming apparatus, and
in a case where the screen data transmission controller determines that preliminary transmission is necessary,
the screen data transmission controller notifies the image forming apparatus that preliminary transmission of the screen data is to be performed, instructs the screen data generator to generate the screen data to be transmitted in preliminary transmission, instructs the screen data transmitter to perform preliminary transmission of the screen data generated by the screen data generator, and together with this, notifies the power supply controller that the power supply state can be shifted to a power saving state so as to cause the power supply controller to shift the power supply state to the power saving state.
